(19) United States
(12) Patent Application Publication
(10) Pub. No.: US 2023/0249412 A1
(43) Pub. Date: Aug. 10, 2023

(54) FORCE-TRANSMITTING DEVICE AND METHOD

(71) Applicant: AKTIEBOLAGET SKF, GOTEBORG (SE)

(72) Inventor: Klaus Dietmar RIPPSTEIN, Ebelsbach (DE)

(21) Appl. No.: 18/101,208

(22) Filed: Jan. 25, 2023

(30) Foreign Application Priority Data
Feb. 4, 2022 (DE) 102022201181.3

(51) Int. Cl. B29C 65/48; B29C 65/56

(52) U.S. Cl. CPC B29C 65/4805; B29C 65/565; B29L 2031/772

(57) ABSTRACT

A method for forming a press connection between a first component and a second component such that force is transmissible between the first component and the second component. A portion of the first component is oversized relative to a portion of the second component, and the portion of second component is configured to receive the portion of the first component. The method includes applying an adhesive to the portion of the first component and/or to the portion of the second component, the adhesive in an uncured state being configured to reduce a coefficient of friction between the portion of the first component and/or the portion of the second component, pressing the portion of the first component into the portion of the second component to form a press connection, and curing the adhesive or allowing the adhesive to cure.

### CROSS-REFERENCE

This application claims priority to German patent application no. 10 2022 201 181.3 filed on Feb. 4, 2022, the contents of which are fully incorporated herein by reference.

### TECHNOLOGICAL FIELD

The present disclosure is directed to a method and apparatus for transmitting force from one component to another component.

### BACKGROUND

In many fields, there is currently a desire to create lighter weight devices by saving weight, in order, for example, to reduce the energy required to move these devices. For example, in the field of electromobility there is the desire to design the vehicles as lightweight as possible in order to increase a range of an electric vehicle.

In order to achieve this desired weight reduction, in addition to providing lighter components, it can also be necessary to make the connections between two or more components lighter. This can be done, for example, by omitting connecting elements such as bolts, screws, nuts, etc. and generating the connections between the two or more components directly, for example, via a press connection.

In a press connection, two components, one of which is oversized compared to the other component, are pressed together in order to achieve a connection therebetween. The greater the oversize between the two components, the greater the force that can be transmitted by the press connection. However, with a large oversize it is necessary to provide a lubricating layer between the first component and the second component, which lubricating layer makes the pressing together possible. However, this lubricating layer remains to a certain extent even after the two components are pressed together and can disadvantageously affect the level of the transmissible force.

### SUMMARY

It is therefore an aspect of the present disclosure to provide an improved press connection between a first and a second component that makes possible an improved force transmission.

In the following, a force-transmitting device is presented in which a first component is connected to a second component a press connection (press fit). The first component and the second component are configured to transmit a force onto the respective other component. In particular, the first and/or the second component can be a single component or a group of different components that are, for example, connected to one another directly or indirectly. For example, the first component can be a shaft, and the second component can be a bearing assembly. Furthermore, the first component is oversized relative to the second component.

In order to increase the force that is transmissible between the first component and the second component, an adhesive layer, serving as lubricating layer during the assembly, is provided between the first component and the second component. During the assembly, the adhesive acts as a lubricating layer or lubricating film that facilitates the press connection between the first component and the second component by reducing a coefficient of friction between the first and the second component. After assembly, the coefficient of friction between the first and second components increases again as the cohesion and adhesion of the adhesive develops so that the force that can be transmitted by the compression joint is increased, particularly compared to a conventional compression joint.

The first component has an oversize, in particular an oversize according to the definitions that are specified, for example, in DIN 7190, of at least 5‰, preferably between 8‰ and 15‰. This makes it possible to increase a normal force that acts in the press connection between the first and the second component and to thereby increase the force transmissible from the first component onto the second component.

According to a further exemplary embodiment, an adhesive that forms the adhesive layer is a curing adhesive, in particular a self-curing adhesive. This makes it possible to increase the coefficient of friction between the first and the second component after joining the two components. The adhesive is advantageously suited to cure in the press joint. The adhesive is preferably a chemically and/or anaerobically curing adhesive, such as, for example, an epoxy adhesive or a retaining (joining) adhesive. Alternatively or additionally, heat can also be used in order to promote the curing of the adhesive.

Furthermore, the first component can be hollow, whereby the first component can be designed lighter-weight. Furthermore, the first component can preferably have a cylindrical or conical shape. In particular, a conical shape beneficially makes it easier to center the first component in the second component.

According to a further preferred embodiment, at least one surface of the first and/or the second component, which surface contacts the other component to form the connection, is surface treated and/or has an increased coefficient of friction. For example, the surface may be phosphated, etched, galvanized, and/or blasted, in particular sandblasted and/or shotblasted. This makes it possible to increase the coefficient of friction of the surface in the region that comes into contact with the other component to increase the force transmissible by the press connection. Alternatively or additionally, the adhesive can also be configured to roughen the surface and/or to increase the coefficient of friction of the surface. For example, the adhesive can have etching properties and/or be a filled adhesive, i.e., be an adhesive that is filled with further substances, in particular substances that increase the coefficient of friction.

The force that is transmitted from the first component to the second component is preferably a torque. In conventional press connections, in which the lubricating layer is formed from a lubricant or the like, this lubricating layer can limit the maximum force transmissible by a press connection or the maximum transmissible torque. A conventional press connection therefore cannot be used in certain applications, since the force transmissible by the press connection is lower than the force required for the intended application. In contrast thereto, however, in the described device the maximum transmissible force or the maximum transmissible torque is increased so that the described device can advantageously also be used in a drive shaft of a vehicle. In particular, with the described device in the specified dimensions, the transmissible torque can be essentially doubled.

According to a further aspect of the disclosure, a method is provided for forming a force-transmitting connection between a first component and a second component. The method comprises:

providing a first and a second component, in which the first component has an oversize compared to the second component,

applying a lubricant onto the first and/or the second component, in which the lubricant is an adhesive, and

press-connecting the first and second component.

The method preferably further includes treating the surface of the first and/or second component in the region of the to-be-formed press connection in order to increase a coefficient of friction of the surface. This enables a greater force transmission between the first and the second component. Here the treating of the surface can comprise a phosphating, an etching, a galvanizing, and/or a blasting, in particular sandblasting and/or shotblasting.

According to a further preferred embodiment, the method further includes curing the adhesive. Here a curing adhesive, in particular a self-curing adhesive, can preferably be used. The adhesive is advantageously suited to cure in the press joint. The adhesive is preferably a chemically and/or anaerobically curing adhesive, such as, for example, an epoxy adhesive or a retaining (joining) adhesive. Alternatively or additionally, heat can also be used in order to promote the curing of the adhesive. This reliably enables the formation of cohesion and adhesion of the adhesive. Alternatively or additionally, the adhesive can also be configured to roughen the surface and/or to increase the coefficient of friction of the surface. For example, the adhesive can be a filled adhesive, i.e., an adhesive that is filled with further substances, in particular substances increasing the coefficient of friction. The application of the adhesive can be effected, for example, in a planar or linear manner.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a schematic view of a force-transmitting device according to a first embodiment of the present disclosure.

FIG. 2 is a schematic view of a force-transmitting device according to a second embodiment of the present disclosure.

FIG. 3 is a flow chart for a method for forming a force-transmitting connection between a first component and a second component according to the disclosure.

### DETAILED DESCRIPTION

In the following, identical or functionally equivalent elements are designated by the same reference numbers.

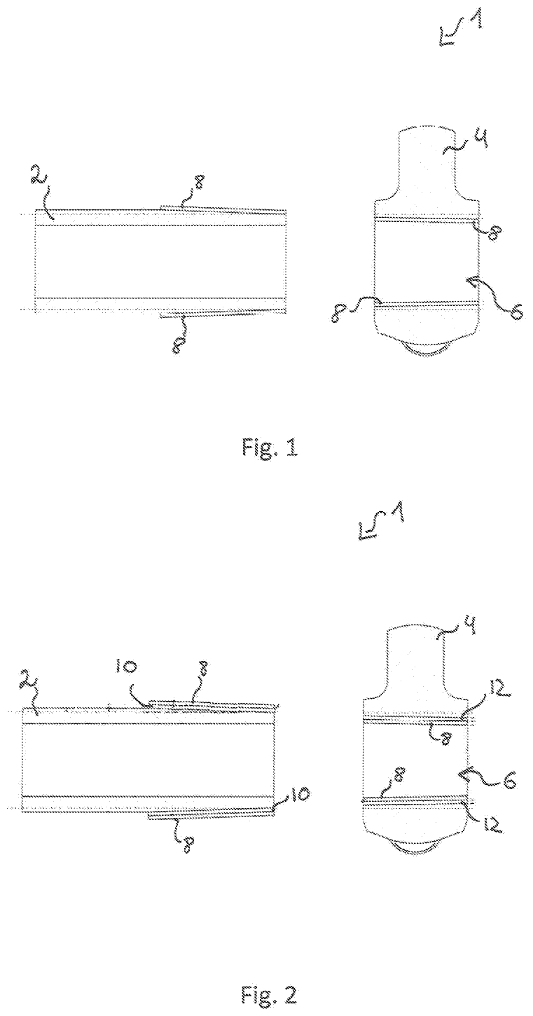

FIG. 1 shows a device 1 according to a first embodiment that is configured to transmit a force, in particular a torque, from a first component 2 to a second component 4. In FIG. 1, the first component 2 is a conical hollow shaft, and the second component 4 is a hub that includes a bore 6. The cone angle of the first component 2 can, for example, fall between 1 and 89.5 degrees. Alternatively the first component 2 can also have a cylindrical shape.

In order to form the device 1, the first and second component 2, 4 are connected to each other by a press connection so that the force can be transmitted from the first component 2 to the second component 4 and vice versa. In order to enable the connection between the first and the second component 2, 4 to transmit the force, a diameter of the first component 2 has an oversize compared to the bore 6 of the second component 4. In FIG. 1, the first component 2 has an oversize of at least 5‰, preferably between 8 and 15‰.

In order to increase the force transmissible from the first component 2 to the second component 4, an adhesive layer 8, which serves as a lubricating layer during assembly, is provided between the first component 2 and the second component 4. In FIG. 1, the adhesive layer 8 is applied in particular in the region in which the first component 2 and the second component 4 will be in contact after the assembly. As can be seen in FIG. 1, the adhesive layer 8 is applied onto both the first component 2 and the second component 4. Alternatively only one of the two components 2, 4 can be provided with the adhesive layer 8.

During the assembly, the adhesive acts as a lubricating layer that facilitates the formation of the press connection between the first component 2 and the second component 4 by reducing a coefficient of friction between the first and second component 2, 4 through the adhesive layer 8 serving as a lubricating layer. After assembly, the adhesive cures so that the coefficient of friction between the first and the second component 2,4 increases again, and the force transmissible by the press connection is thereby increased, in particular in comparison to a conventional press connection.

The adhesive used for the adhesive layer 8 is a curing adhesive so that after assembly the coefficient of friction between the first and the second component 2, 4 is increased by the curing. For example, the adhesive can be an anaerobically curing adhesive and/or a chemically curing adhesive and advantageously heat can be used in order to promote the curing of the adhesive.

FIG. 2 shows a device 1 according to a second embodiment. The device of FIG. 2 differs from the device 1 of FIG. 1 in that the surface 10 of the first component 2 and the surface 12 of the second component 4 that come into contact with each other during the connecting have an increased coefficient of friction. This can be achieved, for example, by a corresponding surface treatment. For example, the surface may be phosphated, etched, galvanized, and/or blasted, in particular sandblasted and/or shotblasted. In FIG. 2, both the surface 10 and the surface 12 are treated. Alternatively, also only one of the two surfaces 10, 12 can be treated. Alternatively or additionally, the adhesive can also be configured to roughen the surfaces 10, 12 and/or to increase the coefficient of friction of the surfaces 10, 12. For example, the adhesive can have etching properties and/or be a filled adhesive, i.e., be an adhesive that is filled with further substances, in particular substances increasing the coefficient of friction.

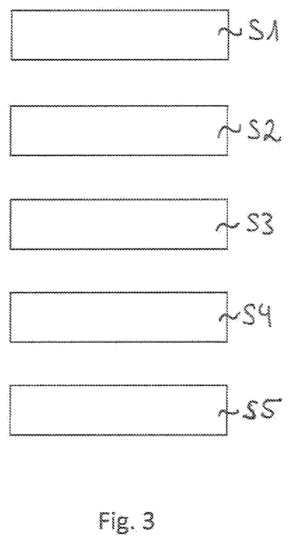

FIG. 3 shows a schematic flow chart for a method for forming a force-transmitting connection between a first component 2 and a second component 4. In a first step S1, the method comprises providing the first and the second component 2, 4, in which the first component 2 has an oversize compared to the second component 4. In step S2, lubricant is applied onto the first and/or the second component 2, 4, the lubricant being a curing adhesive. The application of the adhesive can be effected, for example, in a planar or linear manner.

Then the first and the second component 2, 4 are pressed together in a step S3, and finally in a step S4 the adhesive cures. In order to increase the maximum force that can be transmitted between the first component 2 and the second component 4, the method can furthermore include performing a treatment S5 in the region of the press connection of the surfaces 10, 12 of the first and/or second component 2, 4, in order to increase a coefficient of friction of the surfaces 10, 12. Here the surface treatment can be effected, for example, before applying the adhesive or also during the application of the adhesive—for example, by using an adhesive that can be configured to roughen the surfaces 10, 12 and/or to increase the coefficient of friction of the surfaces 10, 12.

In summary, due to the use of an adhesive layer 8 as a lubricating layer to facilitate the pressing together of the first and second component 2, 4, the force, in particular a torque, transmissible from the first component 2 onto the second component can be increased. Here it can be made possible in particular that with the dimensions given, the force or the torque that can be transmitted between the first component 2 and the second components 4 can essentially be doubled. This makes possible it possible among other things to also use the described device 1 or the described method for connections in vehicles.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved force transmitting devices and methods.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Device
2 First component
4 Second component
6 Bore
8 Adhesive layer
10, 12 Surface region
10
S1-S5 Method steps

What is claimed is:

1. A method for forming a press connection between a first component and a second component such that a force is transmissible between the first component and the second component, wherein a portion of the first component is oversized relative to a portion of the second component, and wherein the portion of second component is configured to receive the portion of the first component, the method comprising:
applying an adhesive to the portion of the first component and/or to the portion of the second component, the adhesive in an uncured state being configured to reduce a coefficient of friction between the portion of the first component and/or the portion of the second component,
pressing the portion of the first component into the portion of the second component to form a press connection, and
curing the adhesive or allowing the adhesive to cure.

2. The method according to claim 1, including:
before applying the adhesive, treating a surface of the portion of the first component and/or a surface of the portion of the second component to increase a coefficient of friction of the surface.

3. The method according to claim 2, wherein the treating comprises phosphating, etching, galvanizing, sandblasting and/or shotblasting.

4. The method according to claim 1,
wherein the portion of the first component is a projection and the portion of the second component is an opening, and
wherein projection is oversized relative to the opening by 8 to 15‰.

5. The method according to claim 1,
wherein the adhesive is an anaerobically curing adhesive and/or a chemically curing adhesive.

6. The method according to claim 1,
wherein the force is a torque.

7. A force-transmitting device comprising:
a first component including a projection and a second component including an opening,
wherein the projection is oversized relative to the opening and inserted in the opening to form a press connection between the projection and the opening
wherein a layer of adhesive is provided between the projection and the opening, and
wherein the adhesive in an uncured state is configured to reduce a coefficient of friction between the projection and the opening.

8. The device according to claim 7,
wherein the projection is oversized by between 8 and 15‰ relative to the opening.

9. The device according to claim 7,
wherein the adhesive is an anaerobically curing adhesive and/or a chemically curing adhesive.

10. The device according to claim 7,
wherein the projection is hollow and has a cylindrical or conical shape.

11. The device according to claim 7,
wherein a surface of the projection and/or a surface of the opening is surface treated to increase a coefficient of friction.

12. The device according to claim 7,
wherein a surface of the projection and/or a surface of the opening is phosphated, etched, galvanized, sandblasted and/or shot blasted.

13. The device according to claim 7,
wherein the press connection is configured to transmit a torque between the first component and the second component.
